(19) United States
(12) Patent Application Publication
(10) Pub. No.: US 2026/0257434 A1
(43) Pub. Date: Sep. 3, 2026

(54) COMPOSITE MANUFACTURING METHOD FOR SERVICES TROUGHS

(71) Applicant: Fibex Limited, Kidderminster, West Midlands (GB)

(72) Inventors: Steven Menday, Kidderminster, West Midlands (GB); Ashley Jones, Kidderminster, West Midlands (GB)

(21) Appl. No.: 19/489,970

(22) PCT Filed: Sep. 27, 2024
(86) PCT No.: PCT/EP2024/077367

§ 371 Date: Dec. 4, 2025

(30) Foreign Application Priority Data
Sep. 28, 2023 (GB) 2314946.1
Jul. 10, 2024 (GB) 2410029.9

(51) Int. Cl. B29C 70/48; B29L 16/00; H02G 3/04

(52) U.S. Cl. CPC B29C 70/48; B29L 2016/00; H02G 3/0437

(57) ABSTRACT

The present disclosure is directed towards a method of manufacturing a services trough (10). The services trough comprises a channel (11) and at least one support rib (12) extending around the channel. The method comprises forming the services trough by a closed mould process, being a resin transfer moulding (RTM) process. The RTM process comprises laying up a reinforcement material inside a mould cavity within a mould, closing the mould, supplying resin composition into the mould cavity, and curing the reinforcement material and resin composition in the mould cavity.

### TECHNICAL FIELD

The present disclosure is directed towards a manufacturing method for composites. The disclosure is particularly directed to a method of manufacturing a composite trough, particularly for a services trough system.

### BACKGROUND

Services troughs are utilised to provide secure, usually shallow, trenches for cable protection, containment and management. Such troughs are typically installed in the ground and must therefore have sufficient strength and/or mechanical performance to withstand the loads of vehicles passing over them, resist soil/earth loading and resist hydro/thermal loading that may be present. The troughs can, however, be surface mounted in certain applications. The troughs have traditionally been made from concrete.

It is known to use a moulded GRP (Glass Reinforced Plastic) services trough system rather than concrete to provide a cost effective solution that is lightweight, without compromising on strength and/or mechanical performance. GRP services troughs can provide a weight saving of over 90% compared to concrete, allowing for easy installation, reduced labour and improved safety. Existing moulded GRP services troughs are made by an open moulding process such as the hand lay-up method, which combines fibrous reinforcement with a liquid resin composition, which is applied by hand. This traditional hand layup approach is very widely available in the market and has long been the generally accepted practice in the art. This makes it easier to find manufacturing capacity/capability, materials and operators for the traditional hand layup approach.

### SUMMARY

An object of the present disclosure is to provide an improved method of manufacturing a composite trough system, particularly a services trough system. The services trough may be referred to as ducting, trunking, a trough and/or a cable trough and may be for cable or other such services management.

The present invention provides a method, services trough and services trough system in accordance with the claims. The method comprises forming a services trough by a closed mould process, wherein the closed mould process is a resin transfer moulding (RTM) process. In the RTM process, a reinforcement material is laid up inside a mould cavity within a mould, the mould is closed, resin composition is supplied (for example injected) into the mould cavity, and the reinforcement material and resin composition is cured in the mould cavity. The RTM process generally relies upon drawing the resin composition through a dry fibre preform, comprising the reinforcement material, loaded into the closed cavity mould.

The traditional hand layup approach has long remained the standard manufacturing method because of the availability of manufacturing capacity/capability, materials and operators. However, in accordance with the present invention, by using a closed mould manufacturing process such as RTM, higher quality laminates can be achieved than from traditional hand layup method. With higher performance laminates, it is then possible to design structures which are more efficient in their material use, and better able to carry the load and meet the mechanical performance requirements. In particular, materials can be taken from the design, reducing costs without degrading mechanical performance.

In addition, with such processes, there is much greater process control, reducing part to part variability. This has a positive effect on scrap rates, rework, and the required safety factors needed to achieve a given load. Again, this allows the designer to take out surplus materials, thus reducing the cost and complexity of manufacture.

The use of a closed mould manufacturing process, particularly RTM, is contrary to the long established and accepted practice of the traditional hand layup approach due to its higher cost and higher operator skill levels. The present disclosure therefore provides a lightweight alternative to concrete troughs and covers and a more effective manufacturing method to that of the prior art.

A significant challenge for forming services troughs by RTM is to ensure full saturation of the support ribs and rib laminates with the resin composition, without leaving any dry or defective areas on the part. The resin composition naturally takes the path of least resistance through the mould cavity/reinforcement material, so a challenge is to ensure that this path fully wets out (saturates) the part with resin composition before it cures. In accordance with the present disclosure, the port through which a vacuum or pressure differential is applied is located on the mould where the at least one support rib, and optionally at least one lower rib extending between support ribs, will be formed. The resin is then supplied to the mould at rims thereof, particularly in the region of first and second channel upper edges. Thus, resin composition can effectively be drawn into the at least one support rib. The at least one lower rib can also aid resin composition flow between support ribs, ensuring the resin composition can reach all of the mould cavity for effectively forming the trough.

The present disclosure provides a services trough comprising a channel and at least one support rib extending around the channel. The services trough is preferably formed in accordance with the method disclosed herein. The trough is designed as a structural outer skin, reinforced with the at least one support rib that runs around the perimeter of the outer skin. The structural outer skin is formed by the reinforcement material and resin composition curing in the mould cavity during the RTM process. The at least one support rib comprises a preform, which may provide substantially no structural support in use and may instead be utilised in the manufacturing method to assist with forming the at least one support rib.

The channel may be U-shaped, optionally between first and second channel upper edges, optionally wherein the first and second channel upper edges comprise first and second rebates respectively for receiving a cover for closing the channel. The channel may comprise an inner surface extending between the first and second channel upper edges, optionally wherein the inner surface comprises opposing planar inner channel sides and a planar channel base, wherein optionally the planar channel base is substantially perpendicular to the planar inner channel sides and/or the inner surface further comprises elongate channel corners extending between the planar channel base and the planar inner channel sides.

The services trough and/or channel may be elongate and may extend between first and second end faces, optionally wherein the first and second end faces are substantially vertical, planar, parallel and/or identically shaped, optionally wherein the services trough extends between the first and second end faces by at least 500 mm. The first and second channel upper edges and/or first and second rebates may extend between the first and second end faces.

The at least one support rib may extend outwardly from the channel. The at least one support rib may extend around the channel between the first and second channel upper edges. The at least one support rib may comprise a support rib base extending between first and second support rib outer sides, the first and second support rib outer sides extending between the support rib base and first and second channel upper edges. The draft angle between the support rib base and the first and second support rib sides may be over 90 degrees, optionally in the range of about 90 to about 100 degrees. The at least one support rib may comprise first and second inner support rib sides extending outwardly from channel to the support rib base and to the first and second support rib sides, optionally wherein inner edges of the first and second inner support rib sides meet, extend around and confirm to the outside of the channel. The first and second inner support rib sides may extend upwardly from the support rib base non-parallel to one another, optionally wherein the draft angle between the first and second inner support rib sides and support rib base is over 90 degrees, optionally in the range of about 90 to about 100 degrees.

The present disclosure further provides a services trough system comprising the trough of the present disclosure and a cover for mounting to the trough. The cover may be able to support at least 3.5 tonne, at least 25 tonne and/or at least 40 tonne loads when mounted to the trough. The cover may be mounted to first and second channel upper edges, optionally to first and second rebates of the first and second channel upper edges.

The trough may be generally elongate. The trough, particularly the channel thereof, may have at least a 300 mm depth and/or at least a 450 mm internal width.

The trough may be configured for external use and may be configured to bear the imposed load of a vehicle of at least 1 tonne and/or a load of at least 10 tonnes, at least 30 tonnes or at least 40 tonnes. The trough may be designed to meet the load classes of BS EN 1433 classes A15, B125, C250 and/or D400.

The trough may be configured to receive a plurality of cables, such as for power and communications, and/or other such services (such as drainage and/or fluid (e.g. water, gas) pipes). The trough may have smooth internal walls (particularly of the channel) to allow for easier cable pulling, thereby avoiding cable damage, and to avoid damage to services routed within the trough. The trough may be suitable for applications such as substations, power stations, wind farms, biomass plants, gas compressor plants, waste water treatment plants, petrochemical plants, hospitals and commercial infrastructure.

The trough may be configured to be installed in the ground and/or to be surface mounted. The trough may be configured to have sufficient strength and/or mechanical performance to withstand the loads of vehicles passing thereover, resist soil/earth loading and/or resist hydro/thermal loading.

The trough may comprise fibre reinforced polymer or plastic (FRP), glass reinforced plastic (GRP), continuous fibre composite material or similar.

Although not RTM, the services trough may be manufactured by another closed mould process such as resin infusion or resin film infusion.

### BRIEF DESCRIPTION OF THE DRAWINGS

By way of example only, embodiments of the method, services trough and services trough system in accordance with the present disclosure are now described with reference to, and as shown in, the accompanying drawings, in which:

FIG. 1A illustrates a perspective view of the services trough of the present disclosure;

FIG. 1B illustrates a bottom view of the base of the trough of FIG. 1A;

FIG. 1C illustrates a top view of the trough of FIG. 1A;

FIG. 1D illustrates a side view of the trough of FIG. 1A;

FIG. 1E illustrates an end view of the trough of FIG. 1A. The trough of FIG. 1A to 1E may be substantially symmetrical such that the unshown side and end views are identical to the shown side and end views respectively;

FIG. 2A illustrates a perspective view of a first mould tool for forming the services trough of FIG. 1;

FIG. 2B illustrates a top view of the first mould tool of FIG. 2A;

FIG. 2C illustrates an end view of the first mould tool of FIG. 2A;

FIG. 2D illustrates a side view of the first mould tool of FIG. 2A. The first mould tool may be substantially symmetrical such that the unshown side and end views are identical to the shown side and end views respectively;

FIG. 3A illustrates a perspective view of a second mould tool for nesting with the first mould tool of FIG. 2A for forming the services trough of FIG. 1A;

FIG. 3B illustrates a magnified view of area A of the second mould tool of FIG. 3A;

FIG. 3C illustrates a top view of the second mould tool of FIG. 1A;

FIG. 3D illustrates a side view of the second mould tool of FIG. 1A;

FIG. 3E illustrates an end view of the second mould tool of FIG. 1A. The second mould tool may be substantially symmetrical such that the unshown side and end views are identical to the shown side and end views respectively; and

FIG. 4 illustrates an exploded perspective view of the services trough and first and second mould tools of the preceding figures.

### DETAILED DESCRIPTION

The present disclosure relates to a method of manufacturing a services trough, a services trough and a services trough system. The method comprises a closed mould process, particularly RTM, such as light RTM, vacuum assisted RTM, vacuum assisted resin infusion (VARI), resin film infusion (RFI) and/or Vacuum Assisted RTM (VARTM). The process may use a small amount of pressure to push resin composition into a closed mould, such as by using a pressure differential, such as a vacuum, to pull the resin composition through the mould. The mould may contain a preloaded pack of dry fibrous material such as woven fibreglass, carbon or similar, arranged in specific locations and orientation to form the geometry and provide strength and sufficient mechanical performance to the end part (the trough). The closed mould may be vacuum sealed and may be injected and/or supplied with the resin composition, which may comprise a resin and a catalyst which produces an exothermic reaction such that the part is cured and then released from the mould.

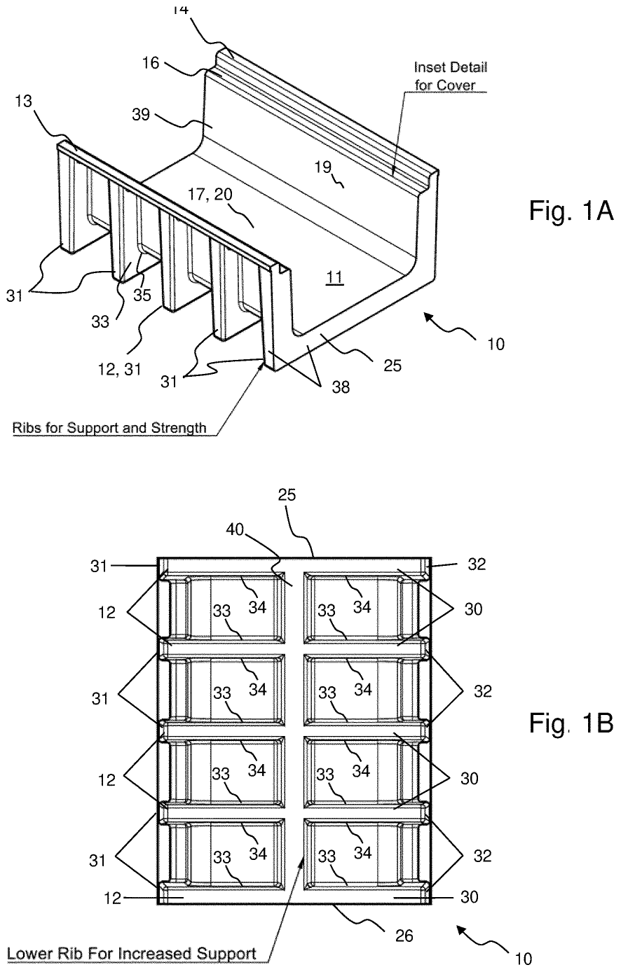

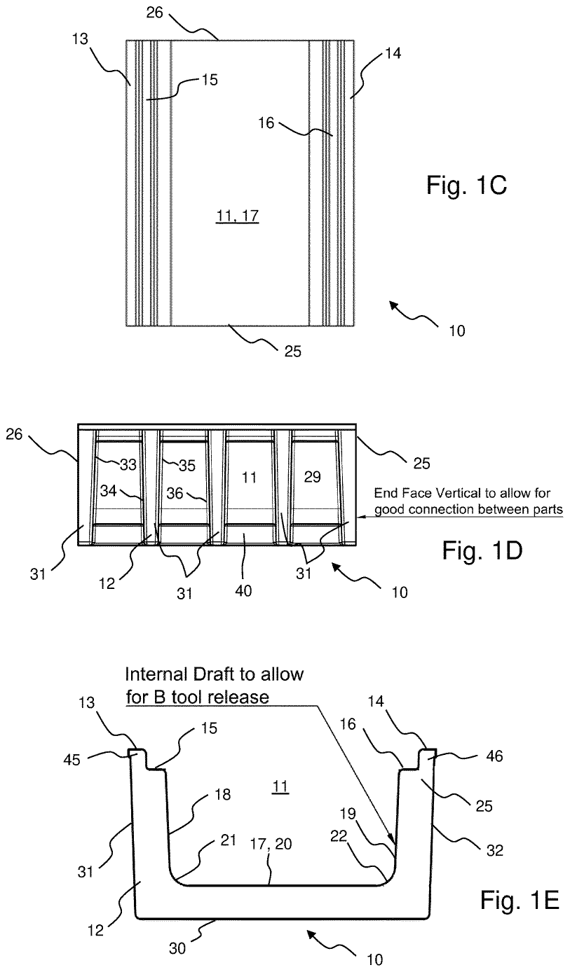

The services trough system comprises a trough 10, an embodiment of which is illustrated in FIGS. 1A to 1E, and a cover (not illustrated) for mounting to the trough 10. The trough 10 comprises a channel 11 and at least one support rib 12 extending around the channel 11. By virtue of the method of the present disclosure, the channel 11 and at least one rib 12 are unitary and/or monolithic such that they are very strongly connected together.

The channel 11 is U-shaped between first and second channel upper edges 13, 14 located on either side of the width of the trough 10. The first and second channel upper edges 13, 14 may comprise first and second rebates 15, 16 respectively for receiving the cover for closing the channel.

The channel 11 may comprise a channel inner surface 17 extending between the first and second channel upper edges 13, 14 and particularly between the first and second rebates 15, 16. The channel inner surface 17 may comprise opposing planar inner channel sides 18, 19 and a planar channel base 20. The planar channel base 20 may be substantially perpendicular to the planar inner channel sides 18, 19. The channel inner surface 17 may further comprise elongate channel corners 21, 22 extending between the planar channel base 20 and the planar inner channel sides 18, 19.

The channel 11 is substantially thin walled, such as by being thinner than the at least one support rib 12. The channel 11 comprises a channel outer surface 29 on the opposing side of the thin wall to the channel inner surface 17. The channel 11 may comprise only the structural outer skin, formed by the reinforcement material and resin composition, and may not be formed by any preform or the like therein.

The illustrated services trough 10 and/or channel 11 is elongate, such as by having a longer length than width, and is a straight section. The services trough 10 and/or channel 11 extends along its length between first and second end faces 25, 26. The first and second end faces 25, 26 are substantially vertical, planar, parallel and/or identically shaped. This may provide the first and second end faces 25, 26 with a good connection to other troughs of the same design (optionally as different shaped sections).

The services trough 10 may extend between the first and second end faces 25, 26 by at least 500 mm. The first and second channel upper edges 13, 14 and/or first and second rebates 15, 16 extend between the first and second end faces 25, 26, such as elongately along the length of the services trough 10.

The trough 10 may not be straight as illustrated and may instead be a tee, comprising three end faces 25, 26 (two parallel to one another, a third perpendicular to the other two) with first and second channel upper edges 13, 14 and/or first and second rebates 15, 16 extending therebetween. Alternatively the trough 10 may be a right angle and/or (optionally wide) radius or curved section, comprising two end faces 25, 26 (non-parallel to one another) with first and second channel upper edges 13, 14 and/or first and second rebates 15, 16 extending therebetween.

The at least one support rib 12 is for providing support, strength and mechanical performance to the channel 11 of the trough 10. The at least one support rib 12 extends outwardly from the channel 11 and around the channel outer surface 29. The at least one support rib 12 extends around the channel 11 between the first and second channel upper edges 13, 14. The or each at least one support rib 12 may comprise a support rib base 30 extending between first and second support rib outer sides 31, 32. The first and second support rib outer sides 31, 32 may extend between the support rib base 30 and first and second channel upper edges 13, 14.

The support rib base 30 and the first and second support rib sides 31, 32 may be substantially planar. The or each at least one support rib 12 has a thickness, in the direction of the length of the trough 10, that is substantially less than the length of the trough 10, such as by being less than 50%, less than 25% or less than 15% of the length of the trough 10. The draft angle between the support rib base 30 and the first and second support rib sides 31, 32 is over 90 degrees and may be in the range of about 90 to about 100 degrees. Such a draft angle allows for the trough 10 to be more easily removed from the mould after the moulding process.

The or each at least one support rib 12 may comprise first and second inner support rib sides 33, 34 extending outwardly from channel 11 to the support rib base 30 and to the first and second support rib sides 31, 32. The inner edges 35, 36 of the first and second inner support rib sides 33, 34 meet, extend around and/or conform to the outside of the channel 11.

As best illustrated for the middle three ribs 12 of the trough 10 in FIG. 1D, the first and second inner support rib sides 35, 36 extend upwardly from the support rib base 30 non-parallel to one another. The draft angle between the first and second inner support rib sides 35, 36 and support rib base 30 may be over 90 degrees and may optionally be in the range of about 90 to about 100 degrees.

The at least one support rib 12 preferably comprises a plurality of support ribs 12. The illustrated straight section preferably comprises at least three support ribs 12, at least four ribs 12 or five ribs 12 as illustrated. The spacing between the support ribs 12 may be sufficiently great to allow space for ‘core drilling’ of the trough 10 (through the channel sides 21, 22 or base 20) to allow cables/services/drainage to be added to the trough 10. The spacing, sizing and frequency of the support ribs 12 can be altered to suit the end application.

Support ribs 12 may be formed adjacent to and/or at the first and second end faces 25, 26 of the trough 10 as illustrated. These end support ribs 12 may be narrower (i.e. extend along the elongate direction or length of the channel 11 by less) than the other support rib(s) 12. The end support ribs 12 may substantially form the first and second end faces 25, 26. The first and second end faces 25, 26 may be formed by inner support rib sides of the end support ribs 12 and may extend upwardly from the support rib base 30 substantially perpendicularly to the support rib base 30. Thus the first and second end faces 25, 26 may be substantially vertical for good or effective connection to other troughs 10.

The services trough 10 may also comprise at least one lower rib 40 or a plurality of lower ribs 40 extending along an underside of the channel 11 perpendicular to the at least one support rib 12 and/or along the length of the trough 10. As best illustrated in the base view of FIG. 1, the lower ribs 40 provide increased support and provide lateral and vertical strength and stiffness. During moulding, the at least one lower rib 40 assists with stabilising the mould skin and increasing the part effective thickness. A pair of lower ribs 40 may be provided rather than the single rib 40 illustrated. The lower rib(s) 40 may extend between the support ribs 12 and, in the case of there being a plurality of lower ribs 40, may be parallel to one another along the length of the trough 10.

The first and second channel upper edges 13, 14 comprise first and second channel upper edge bodies 45, 46, which may extend upwardly from the first and second rebates 15, 16. The first and second channel upper edge bodies 45, 46 may be substantially solid and/or monolithic, with no foam core or sandwich panel. The first and second channel upper edge bodies 45, 46 may extend between the first and second end faces 25, 26 and may extend, on the outside of the trough 10, from the top of the trough 10 down to the at least one support rib 12. The height of the first and second channel upper edge bodies 45, 46 may be substantially the same as the height of the first and second rebates 15, 16. The first and second upper edge bodies 45, 46 may provide additional strength and mechanical performance to the trough 11.

The services trough 10 comprises a trough outer surface 38 and a trough inner surface 39. The trough inner surface 39 is generally formed by and/or comprises the channel inner surface 17, the first and second rebate 15, 16 and the first and second channel upper edges 13, 14. The trough outer surface 38 is generally formed by and/or comprises the rib(s) 12, 40, the channel outer surface 29 and the first and second ends 25, 26.

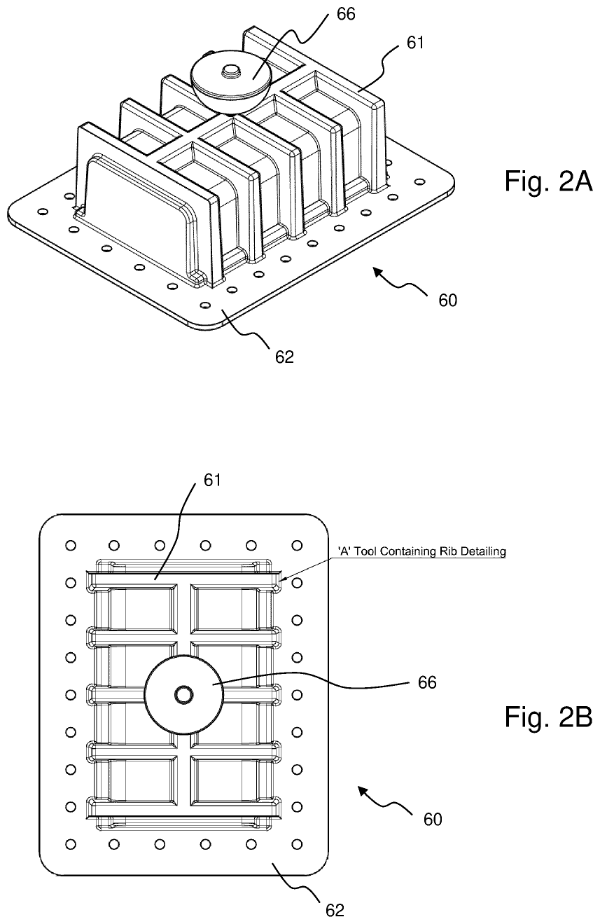

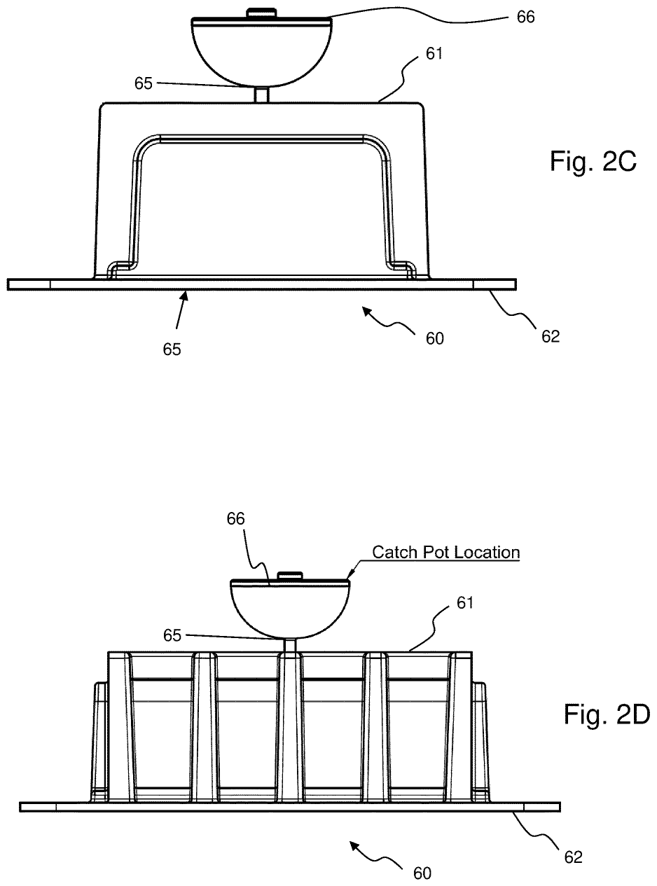

The method of manufacturing the services trough 10 of the present disclosure comprises forming the services trough 10 by a closed mould process. The closed mould process is preferably a resin transfer moulding (“RTM”) process. The RTM process may be light RTM, vacuum RTM, vacuum assisted resin infusion (VARI), resin film infusion (RFI) and/or Vacuum Assisted RTM (VARTM). The trough 10 may be formed via a mould 50 formed from mould tools 60, 70 illustrated in FIGS. 2A to 4.

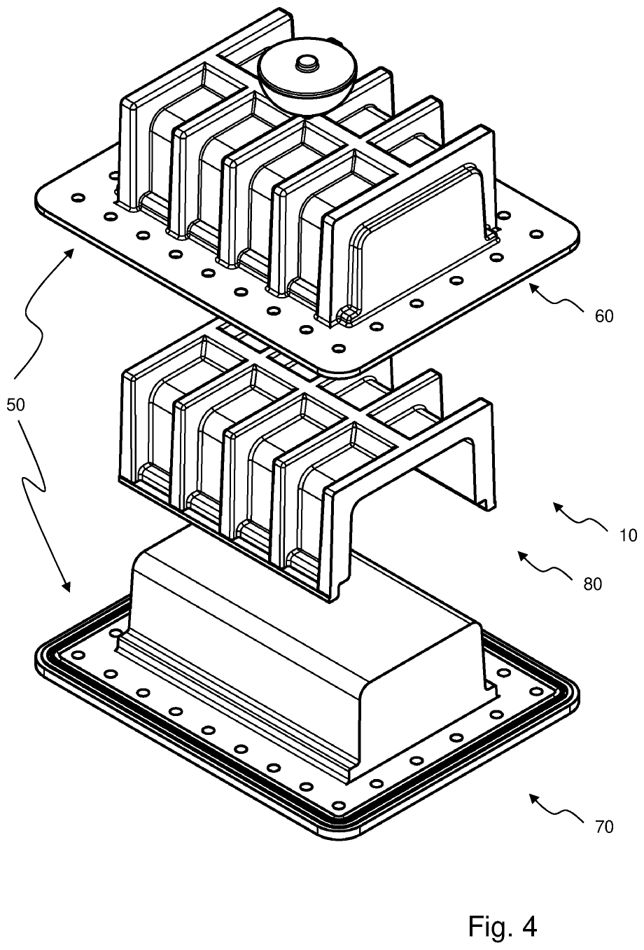

Generally, in the method a reinforcement material, which is a dry fibre materials pack, is laid up inside a mould cavity 80 (illustrated generally in FIG. 4, although the mould cavity 80 is only formed when the first and second mould tools 60, 70 are joined together and not exploded as in FIG. 4) within the mould 50. The laying up is dry and resin composition is not applied during the lay-up process. The mould 50 is closed and the resin composition is supplied, injected and/or drawn into the mould cavity 80 under a pressure differential within the mould cavity 80. The reinforcement material and resin composition are cured in the mould cavity 80, thereby forming the trough 10.

The method comprises providing and/or forming the mould 50 for the trough 10. According to a preferred embodiment of the present invention, the mould 50 comprises first and second mould tools 60, 70 nestable or mateable together to define a mould cavity 80 therebetween. The mould cavity 80 has the shape and volume of the trough 10.

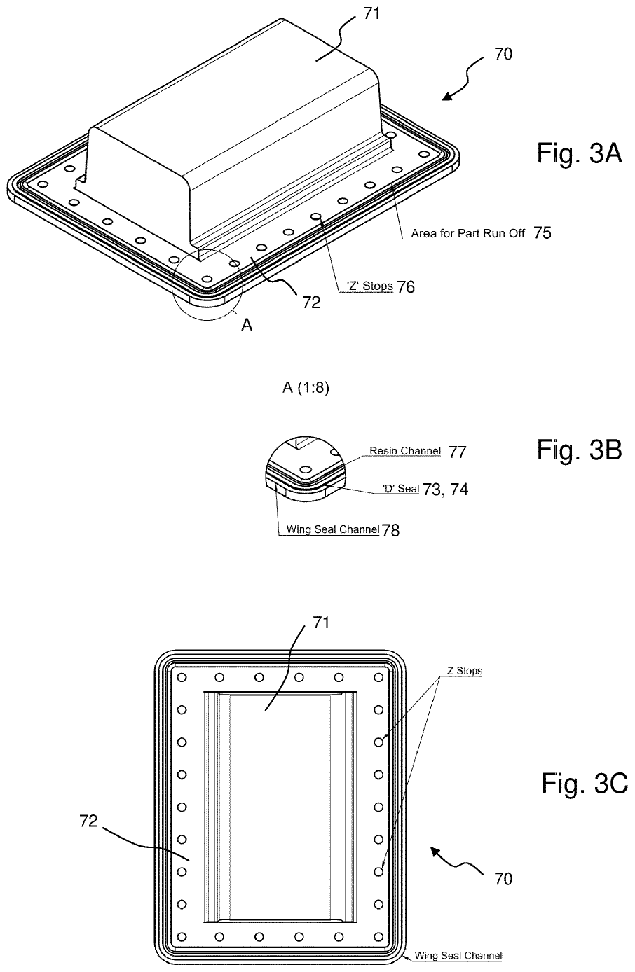

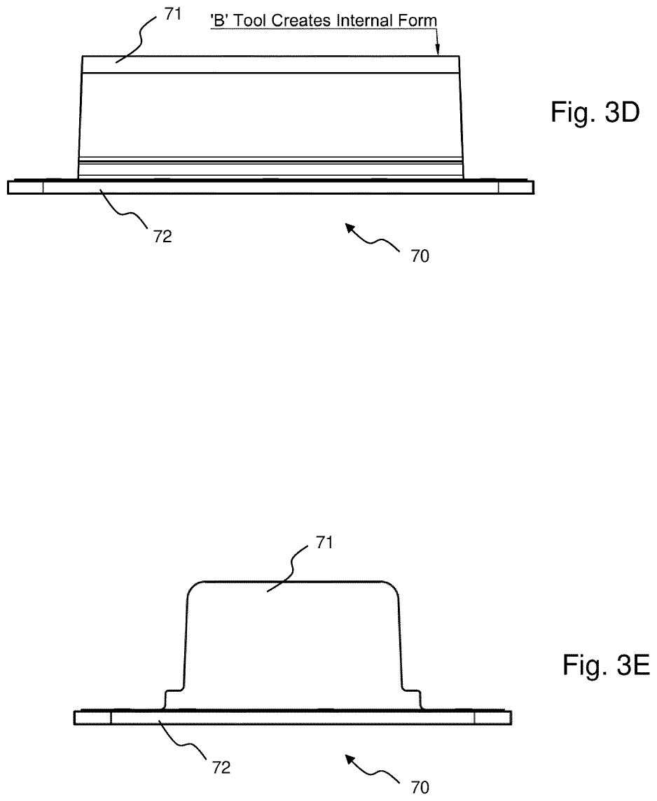

The first mould tool 60, which is the female mould, is illustrated in FIGS. 2A-2D and the second mould tool 70, which is the male mould, is illustrated in FIG. 3A-3E. The first and second mould tools 60, 70 may generally have the same rigidity. However, particularly if the RTM process is RTM-light, the second mould tool 70 may be rigid and/or the first mould tool 60 may be semi-rigid or less rigid than the first mould tool 60 (i.e. flexible enough that it can be separated from the second mould tool 70 and trough 11 after curing).

The first mould tool 60 generally has the shape of the outside/outer surface 38 of the trough 10 and comprises a first mould tool body 61 in the shape of the outside of the support rib(s) 12, lower rib(s) 40, and channel 11. The first mould tool body 61 may also be for forming the end faces 25, 26 of the trough 10. In particular, the first mould tool body 61 comprises a first mould tool cavity 63 formed by the first mould tool body 61, the first mould tool cavity 63 having the same shape as the trough outer surface 38. In other words, the first mould tool 60 and first mould tool body 61 are thin walled, forming the first mould tool cavity 63 therein.

The first mould tool 60 may include a port 65 for receiving a vacuum resin catch pot 66 and/or for the application of a vacuum, as discussed further below. The first mould tool 60 may comprise a first mould tool rim 62 around the first mould tool body 61 for engaging with the second mould tool 70.

The second mould tool 70 generally has the shape of the inside/inner surface 39 of the trough 10 and comprises a second mould tool body 71 in the shape of the inside of the channel 11 (i.e. the channel inner surface 17, the first and second rebate 15, 16 and the first and second channel upper edges 13, 14). The second mould tool 70 may comprise a second mould tool rim 72 around the second mould tool body 71 for engaging with the first mould tool 60, particularly the first mould tool rim 62 thereof. In alternative embodiments, the second mould tool 70 may comprise a flexible vacuum bag, or other vacuum integral material designed to create a seal with the first mould tool 60.

Since the first and second mould tools 60, 70 have substantially the same shape as the trough 10, references herein to parts of the trough 10 equally apply to the equivalent parts of the first and second mould tools 60, 70.

The first and second mould tools 60, 70 may be sealed together around the first and second mould tool rims 62, 72. In particular, at least one of the rims 62, 72 (in the illustrated example the second mould tool rim 72) comprises a seal groove 73 for receiving a seal 74. A seal 74, which may be a D seal as illustrated, may be mounted in the groove 73 and/or between the first and second mould tools 60, 70. A vacuum may be applied at the seal 74 and/or between the first and second mould tools 60, 70 and may be applied at about −1 bar. Alternative sealing mechanisms may be implemented.

The second mould tool rim 72 may further comprise an area for run off 75 of the resin composition from the trough, z stops 76, a resin channel 77 and/or a wing seal channel 78 as illustrated. The area for run off 75 is an area where excess resin from the manufacturing process may gather/collect. Typically this is off the part, outside the area of the final part.

The z stops 76 are hard points in the mould tools 60, 70 that ensure the mould 50 closes to the same position each time, without over/under compressing the dry fibre preform/reinforcement material. The resin channel 77 is a small feature in the mould cavity 80 adjacent to the resin inlet, which allows for rapid dispersion and preheating of the resin, dropping the resin viscosity and improving in mould resin flow. The wing seal channel 78 (or mould seal) is a static seal which runs around the circumference of the mould tools 60, 70. The seal prevents vacuum leaks into/out of the mould 50, and ensure that the resin remains within the mould cavity 80.

The present disclosure provides a method of manufacturing the trough 10, particularly by using the mould 50. Generally, reinforcement material is added to the mould cavity 80, the mould 50 is closed and the resin composition is added to the mould 50 to form the trough 10.

The reinforcement material is preferably laid up in the first mould tool 60 initially, particularly in the first mould tool cavity 63 (which at least partially forms the mould cavity 80). Prior to provision to the first mould tool 60 and mould cavity 80, the reinforcement material may be at least partially formed using a separate preform tool to lay the materials onto, before transferring the preform to the first mould tool 60 and mould cavity 80 and/or may be formed on a secondary item of preform tooling with nominally the same geometric shape as at least part of the first mould tool 60.

The reinforcement material may be in the form of a sheet or mat and may be or comprise dry fibre. The reinforcement material may be applied as a single ply or may be applied as a plurality of at least partially overlapping plies. The reinforcement material may comprise at least one of woven glass, glass, carbon, flax, a randomly orientated fibre product and a chopped strand mat. The reinforcement material may comprise at least one of a unidirectional reinforcement material, biaxial reinforcement material and/or multiaxial reinforcement material. The materials may, for example, be a combination of unidirectional, biaxially and multiaxially woven fibreglass materials. The reinforcement material preferably comprises woven glass fabric(s), since they aid resin composition flow and provide improved mechanical performance.

The method may comprise forming at least one preform comprising the reinforcement material and laying up the reinforcement material may comprise locating the at least one preform in the mould cavity 80. The at least one preform may be manufactured by forming a foam core in a predetermined shape and at least partially wrapping the reinforcement material (e.g. woven glass) around the foam core. The foam core may be polyurethane foam or may comprise a different foam material, such that the foam core is a semi-structural foam core, with sufficient mechanical and thermal properties so as to withstand process induced deformation. The end trough 10 will include the foam therein after forming, although the foam may provide minimal or no structural support.

The at least one support rib 12 is formed using the at least one preform. In particular, at least one foam core is formed in the shape of the at least one support rib 12 and the at least one preform is formed in the shape of the at least one support rib 12 by at least partially wrapping reinforcement material around the at least one foam core.

The at least one lower rib 40 is also formed via at least one preform. In particular, the at least one foam core is formed in the shape of the at least one lower rib and the at least one preform is formed in the shape of the at least one lower rib by at least partially wrapping reinforcement material around the at least one foam core.

To form the support and/or lower rib 12, 40 the reinforcement material may be wrapped entirely around the at least one foam core. In particular, the at least one preform may comprise at least two wraps of reinforcement material, such as by the reinforcement material being wrapped twice around the at least one foam core. The number of wraps is matched to the anticipated mechanical loading on the trough 10, which will also be a function of the size/part geometry. Multiple wraps are desirable to avoid a stress initiation point where the material ends. Furthermore, if the reinforcement material is relatively lightweight, more than two wraps may be required to achieve the desired performance.

Other than for forming the rib(s) 12, 40, no other preforms may be used to form the trough 10.

As the services trough 10 comprises a plurality of support ribs 12 and/or lower rib(s) 40, then a plurality of preforms may be formed separately prior to separately placing them into the mould. Alternatively, the preforms may be connected together and/or formed as a single piece (e.g. as a single piece of foam core) such that they can be inserted into the mould 50 in a single step.

In order to lay up the reinforcement material in the mould 50, the at least one preform for forming the rib(s) 12, 40 is located in the mould cavity 80. In particular, the at least one preform may be inserted into recesses of the first mould tool 60, particularly of the first mould tool cavity 63, for forming the ribs 12, 40. At least one ply, preferably at least two plies, of reinforcement material is/are applied over the at least one preform and along the area of the channel 11, as well as along the outer faces of the mould 50 for forming the first and second end faces 25, 26.

The mould 50 is then closed by locating the second mould tool 70 into the first mould tool 60 and over the reinforcement material and preform(s). The first and second mould tools 60, 70 may then be clamped together so as to form an effective seal therebetween, such that a negative pressure or vacuum can be applied at the seal 74 to maintain it. The negative pressure applied at the seal 75 may be greater than any other negative pressure applied within the mould cavity 80.

The method then comprises the application of a pressure differential across the reinforcement material and preform(s) in the mould cavity 30, which is used to impregnate and drive liquid resin composition through the reinforcement material. The pressure differential across the reinforcement material and preform(s) in the mould cavity 30 may be supplied by applying vacuum only at the resin outlet. Alternatively, the pressure differential may be provided with a combination of vacuum at the outlet, and positive pressure at the resin inlet.

The resin composition is subsequently supplied, such as by being injected or otherwise drawn, into the mould cavity 80 between the first and second mould tools 60, 70. Resin composition may be supplied into the mould cavity 80 via a resin channel and may be supplied and/or injected at a pressure of less that 1 bar (e.g. in the range of from about 0 bar to about 1 bar), such that the seal between the first and second mould tools is maintained even under the pressure of the resin composition. Thus the resin composition is injected into the mould cavity 80 under pressure, optionally in the range of from about 0 bar to about 1 bar.

The resin composition is a liquid and is typically low viscosity to aid flow through the dry fibre preform/reinforcement material. The resin composition will also be selected to have a suitable working time, so that it does not cure too early or too late in the process. The resin composition may be multi-component and may comprise comprising of at least a resin and a curing agent, such as a hardener or catalyst. The resin may comprise at least one polyester resin, vinylester resin, epoxy resin and/or thermoplastics (resins and fibres) and may not be thermoset. The catalyst may also be applied in the resin composition such that an exothermic reaction results such that the trough 10 is cured and can be released from the mould 50. The catalyst may comprise methyl ethyl ketone peroxide (MEKP), such as if the resin composition comprises polyester and/or vinylester resins.

In addition to applying resin composition via a pressure differential, a vacuum may be applied to draw the resin composition through the mould cavity 80 (i.e. vacuum RTM). Such a vacuum is preferably applied in the range of about −0.2 bar to about −0.8 bar. Thus the seal between the first and second mould tools is maintained even under the pressure of this vacuum for the resin composition.

The mould 50 may comprise a plurality of vacuum points or ports to apply a pressure differential, such as the two vacuum points illustrated. One may be at the seal 74, which may always be set on full vacuum (−1 bar). The second may be set at less than full vacuum and may be at the port 65, which forms the exit point to the mould cavity 80. The port 65 is a vent located on top of the first mould tool 60 (shown in FIG. 2A-2D). The mould cavity 80 is evacuated through this port 65. The range of vacuum may be a full −1 bar on the seal 75 and between −0.2 bar and −0.8 bar on the internal vacuum through the port 65.

In preferred embodiments the vacuum is applied to the port 65 of the mould 50, particularly of the first mould tool 60. The port 65 is preferably located in the first mould tool body 61, at a point relatively far from the mould tool rims 62, 72. In particular the port 65 may be located on the support rib base 30 and/or lower rib 40 of the first mould tool 60 as illustrated, being the further point from the mould tool rims 62, 72. By virtue of having the lower rib(s) 40 extending between and connecting the support ribs 40, a resin channel is formed in the first mould tool body 61 along the volume for the lower ribs(s) 40 between the volumes for the support ribs 12. Hence a single port, particularly if vacuum is applied there, can result in a pressure differential or negative pressure being applied to the resin composition entering all of the support ribs 12. The location of the port 65 and inclusion of the lower rib(s) helps to ensure that the resin composition can flow between all support ribs 12 and effectively impregnates all parts of the reinforcement material.

Locating the catch pot 66 at or around the vacuum port 65 allows the catch pot 66 to collect any overflow of resin composition passing through the port 65.

The method comprises curing the resin composition, bound with the reinforcement material, in the mould cavity 80. Curing in the present disclosure refers to hardening, preferably by a chemical process. Typically, the curing is achieved as a result of the reaction of the resin after the addition of a curing agent, such as the hardener or the catalyst. Such curing may be achieved via the catalyst, although heat may additionally or alternatively be applied. For example, the mould 50 and/or resin composition may be preheated prior to addition of the resin composition. Once the trough 10 has cured, it may be released from the mould 50. In particular, the second mould part 70 may be removed from the trough 10 such that the trough 10 may be removed from the first mould part 60 (as illustrated in FIG. 4). The surfaces of the trough 10 will be very smooth due to the use of such a manufacturing method.

The present disclosure therefore provides, in accordance with the following clauses:
1. A method of manufacturing a cable trough, the method comprising forming the cable trough by a closed moulding process.
2. The method of clause 1 wherein the closed moulding process is a resin transfer moulding (“RTM”) process, which is optionally light RTM or vacuum RTM.
3. The method of any one of the preceding clauses comprising: laying up a reinforcement material inside a mould cavity within a mould; closing the mould; injecting resin into the mould cavity ; and curing the reinforcement material and resin in the mould cavity.
4. The method of clause 3 wherein the resin is injected into the mould cavity under pressure, optionally in the range of from about 0 bar to about 1 bar.
5. The method of any one of clauses 3 to 4 comprising applying a vacuum for drawing the resin through the mould cavity.
6. The method of any one of clauses 3 to 5 comprising clamping the mould after closing the mould.
7. The method of any one of clauses 3 to 6 wherein the reinforcement material comprises at least one woven glass mat and/or comprises at least one of a unidirectional reinforcement material, biaxial reinforcement material and/or multiaxial reinforcement material.
8. The method of any one of clauses 3 to 7 comprising forming the mould for the trough, optionally wherein the mould comprises first and second mould tools nestable together to define a mould cavity therebetween, the mould cavity having the shape of the trough.
9. The method of any one any one of clauses 3 to 8 comprising forming at least one preform of the reinforcement material, wherein laying up the reinforcement material comprises locating the at least one preform in the mould cavity.
10. The method of clause 9 comprising forming the at least one preform by forming foam, optionally polyurethane foam, in a predetermined shape and at least partially wrapping the reinforcement material around the foam.
11. The method of any one of the preceding clauses wherein the cable trough comprises: a channel; and at least one support rib extending around the channel.
12. The method of any one of clauses 9 to 11 wherein the at least one preform is for forming the at least one support rib.
13. The method of clause 12 wherein the foam is formed in the shape of the at least one support rib and the preform is formed in the shape of the at least one support rib by at least partially wrapping reinforcement material around the foam.
14. The method of clause 12 or clause 13 wherein the cable trough comprises a plurality of support ribs and a plurality of preforms are formed separately or are connected together.
15. The method of any one of clauses 11 to 14 wherein the cable trough comprises at least one lower rib or a plurality of lower ribs extending along an underside of the channel perpendicular to the at least one support rib, optionally wherein the lower rib(s) are formed via the at least one preform.
16. A cable trough, optionally manufactured according to the method of any one of the preceding clauses, comprising: a channel; and at least one support rib extending around the channel.
17. A cable trough of clause 16 wherein the channel is U-shaped, optionally between first and second channel upper edges, optionally wherein the first and second channel upper edges comprise first and second rebates respectively for receiving a cover for closing the channel.
18. A cable trough of any one of clauses 16 to 17 wherein the channel comprises an inner surface extending between the first and second channel upper edges, optionally wherein the inner surface comprises opposing planar inner channel sides and a planar channel base, wherein optionally the planar channel base is substantially perpendicular to the planar inner channel sides and/or the inner surface further comprises elongate channel corners extending between the planar channel base and the planar inner channel sides.
19. A cable trough of any one of clauses 16 to 18 wherein the cable trough and/or channel is elongate and extends between first and second end faces, optionally wherein the first and second end faces are substantially vertical, planar, parallel and/or identically shaped, optionally wherein the cable trough extends between the first and second end faces by at least 500 mm.
20. A cable trough of any one of clauses 16 to 19 wherein the first and second channel upper edges and/or first and second rebates extend between the first and second end faces.
21. A cable trough of any one of clauses 16 to 20 wherein the at least one support rib extends outwardly from the channel.
22. A cable trough of any one of clauses 16 to 21 wherein the at least one support rib extends around the channel between the first and second channel upper edges.
23. A cable trough of any one of clauses 16 to 22 wherein the at least one support rib comprises a support rib base extending between first and second support rib outer sides, the first and second support rib outer sides extending between the support rib base and first and second channel upper edges.
24. A cable trough of clause 23 wherein the draft angle between the support rib base and the first and second support rib sides is over 90 degrees, optionally in the range of about 90 to about 100 degrees.
25. A cable trough of any one of clauses 16 to 24 wherein the at least one support rib comprises first and second inner support rib sides extending outwardly from channel to the support rib base and to the first and second support rib sides, optionally wherein inner edges of the first and second inner support rib sides meet, extend around and confirm to the outside of the channel.
26. A cable trough of any one of clauses 16 to 25 wherein the first and second inner support rib sides extend upwardly from the support rib base non-parallel to one another, optionally wherein the draft angle between the first and second inner support rib sides and support rib base is over 90 degrees, optionally in the range of about 90 to about 100 degrees.
27. A cable trough system comprising the cable trough of any one of clauses 16 to 26 and a cover for mounting on the cable trough.
28. Any combination of the features of the method, cable trough or cable trough system as described and/or illustrated herein.
29. The method of any one of clauses 1 to 15 wherein the mould comprises first and second mould tools defining a mould cavity therebetween, the mould cavity defining the shape of the trough.
30. The method of clause 29 wherein the first mould tool comprises a first mould tool body in the shape of the outside of the support rib(s), lower rib(s), and channel.
31. The method of clause 30 wherein the first mould tool comprises a vacuum port in the support and/or lower rib(s) area of the first mould tool for the application of a vacuum during the injection of the resin into the mould cavity.
32. The method of clause 31 comprising mounting a resin catch pot to the vacuum port.
33. The method of any one of clauses 29 to 32 wherein the first and second mould tools are sealed to one another at first and second mould tool rims thereof, optionally wherein a vacuum is applied at the seal therebetween during injection of the resin, optionally wherein the vacuum applied is approximately 1 bar and/or greater in magnitude than any other pressure applied to the mould during injection of the resin.
34. The method of any one of clauses 31 to 33 wherein the vacuum applied to the vacuum port has less pressure than that applied at the seal and/or is applied in the range of about −0.2 bar to about −0.8 bar.
35. The method of any one of clauses 29 to 34 wherein the reinforcement material and/or at least one preform is laid up in the first mould tool.

1. A method of manufacturing a services trough, the services trough comprising a channel and at least one support rib extending around the channel, wherein the method comprises forming the services trough by a closed mould process, wherein the closed mould process is a resin transfer moulding (RTM) process comprising:
forming at least one preform comprising the reinforcement material by forming at least one foam core in a predetermined shape and at least partially wrapping the reinforcement material around the foam core, wherein the at least one preform is for forming the at least one support rib, the at least one foam core is formed in the shape of the at least one support rib and the preform is formed in the shape of the at least one support rib by at least partially wrapping reinforcement material around the at least one foam core;
laying up a reinforcement material inside a mould cavity within a mould, comprising locating the at least one preform in the mould cavity;
closing the mould;
supplying resin composition into the mould cavity; and
curing the reinforcement material and resin composition in the mould cavity.

2. The method of claim 1 wherein the RTM process is light RTM or vacuum assisted RTM.

3. The method of claim 1 wherein the resin composition is supplied into the mould cavity under pressure and/or via a pressure differential.

4. The method of claim 1 comprising:
applying a vacuum to the mould cavity for drawing the resin composition through the mould cavity; and/or −clamping the mould after closing the mould.

5. The method of claim 1, wherein the reinforcement material comprises at least one of woven glass, glass, carbon, flax, a randomly orientated fibre product, a chopped strand mat, a unidirectional reinforcement material, a biaxial reinforcement material and/or a multiaxial reinforcement material.

6. (canceled)

7. The method of claim 1 wherein the mould comprises first and second mould tools nestable to define a mould cavity therebetween, the mould cavity defining the shape of the trough.

8. The method of claim 7 wherein the first mould tool comprises a first mould tool body in the shape of the outside of at least the at least one support rib and channel.

9. The method of claim 8 wherein the trough comprises at least one lower rib extending perpendicular to the at least one support rib along an underside of the channel and the first mould tool body is in the shape of the outside of at least the at least one support rib, at least one lower rib and channel.

10. The method of claim 8 wherein the first mould tool comprises a port in the area of the first mould tool for forming the at least one support and/or lower rib, the port being for the application of a pressure differential and/or vacuum during the supply of the resin composition into the mould cavity.

11. The method of claim 7 wherein the first and second mould tools are sealed to one another via a seal between first and second mould tool rims of the first and second mould tools respectively, wherein a vacuum is applied at the seal therebetween during supply of the resin composition.

12. The method of claim 10 wherein:
the vacuum applied at the seal is approximately 1 bar and/or is greater in magnitude than any other pressure applied to the mould during injection of the resin composition; and/or
the pressure applied to the port has less pressure than that applied at the seal and/or is applied in the range of about −0.2 bar to about −0.8 bar.

13.-15. (canceled)

16. The method of claim 15 wherein the services trough comprises a plurality of support ribs and a plurality of preforms are formed separately or are connected together.

17. The method of claim 13 wherein the services trough comprises at least one lower rib extending along an underside of the channel perpendicular to the at least one support rib, wherein the at least one lower rib is formed from the at least one preform.

18. The method of claim 1 wherein the channel is U-shaped between first and second channel upper edges, wherein the first and second channel upper edges comprise first and second rebates respectively for receiving a cover for closing the channel.

19. The method of claim 1 wherein the channel comprises an inner surface extending between the first and second channel upper edges, wherein the inner surface comprises opposing planar inner channel sides and a planar channel base, wherein the planar channel base is substantially perpendicular to the planar inner channel sides and/or the inner surface further comprises elongate channel corners extending between the planar channel base and the planar inner channel sides.

20. The method of claim 1 wherein the services trough and/or channel is elongate and extends between first and second end faces, wherein the first and second end faces are substantially vertical, planar, parallel and/or identically shaped.

21. The method of claim 1 wherein the at least one support rib comprises a support rib base extending between first and second support rib outer sides, the first and second support rib outer sides extending between the support rib base and first and second channel upper edges.

22. The method of claim 21 wherein the draft angle between the support rib base and the first and second support rib sides is over 90 degrees.

23. The method of claim 1 wherein the at least one support rib comprises first and second inner support rib sides extending outwardly from channel to the support rib base and to the first and second support rib sides, wherein inner edges of the first and second inner support rib sides meet, extend around and confirm to the outside of the channel.

24. The method of claim 23 wherein the first and second inner support rib sides extend upwardly from the support rib base non-parallel to one another, optionally wherein the draft angle between the first and second inner support rib sides and support rib base is over 90 degrees, optionally in the range of about 90 to about 100 degrees.

25. A method of manufacturing a services trough system, the method comprising forming a services trough in accordance with claim 1 and forming a cover for mounting on the services trough.
